(19) United States
(12) Patent Application Publication
(10) Pub. No.: US 2007/0136026 A1
(43) Pub. Date: Jun. 14, 2007

(54) GPS-Guided Visual Display

(75) Inventor: Brett Heap, Irvine, CA (US)

Correspondence Address: Rutan & Tucker, LLP.;Hani Z. Sayed, 611 ANTON BLVD, SUITE 1400, COSTA MESA, CA, 92626, US

(73) Assignee: FARHEAP SOLUTIONS INC., Irvine, CA (US)

(21) Appl. No.: 11/563,813

(22) Filed: Nov. 28, 2006

Related U.S. Application Data
(60) Provisional application No. 60/740,532, filed on Nov. 28, 2005.

(51) Int. Cl. G01C 17/00

(52) U.S. Cl. 702/150; 703/1

(57) ABSTRACT

An augmented reality building construction apparatus and system is provided. The apparatus and system has a transparent display, a positioning receiver operatively coupled to the display. Additionally, the apparatus and system has an electronically coupled ground-based positioning system, a microprocessor that displays an electronic content on the transparent display and allows for alignment of the electronic content with images in the real world to produce an augmented reality.

### PRIORITY CLAIM

This utility patent claims priority to the earlier filed provisional patent application entitled: GPS-Guided Visual Display having a Ser. No. of 60/740,532 and filed on Nov. 28, 2005.

### FIELD OF THE INVENTION

The field of the invention is augmented reality building construction tools. More specifically, the present invention relates to a system and method for displaying a graphical and/or visual depiction utilizing Global Positioning technology.

### BACKGROUND

Building construction is a system and method for adding a physical structure to a piece of property. Most types of building constructions are small projects that may add a room to an existing structure or cause the renovation of an existing building. However, most building projects have several stages of operation from the design stage to the implementation of the design into a working building structure. Typically, an individual that wishes to build a structure on a piece of property does not do the actual building of the property themselves. Rather, the individual typically establishes a team of people that will effect the overal development, design and implementation of the building construction. This team may include architects, engineers, construction workers and the like. While their roles overlap, each area of expertise addresses an element of what will be affected by the building construction project.

Most building projects begin with the design elements being reduced to paper or computer to illustrate the desired design of a building and/or structure. Most often, a design team is used for this purpose and may include architects, interior designers, surveyors, engineers and construction workers. The design typically consists of drawings and blueprints that are used by the workers to actually construct the physical property.

After the design elements have been reduced to paper and a working plan has been created, the actual building of the structure begins which involves construction workers that follow the design elements laid out by the design team during the design phase of the construction. Most construction teams have a construction site foreman who first studies a construction plan, or blueprint, then instructs construction workers on where and how something should be built. For example, the foreman may give a general order to the other construction workers that tells the other workers where and how to build a wooden deck. The construction worker in turn may build a wooden deck at the location specified by the foreman. As to the details of where each wooden plank should be nailed, the worker either follows a drawing sheet, or in the case of an experienced worker, simply determines for himself where to nail each wooden plank to build a deck.

Of course in larger projects there are multiple workers and sometimes multiple foremen giving direction to other construction workers. This can become problematic because foremen don't always have the same methods and procedures as other foremen.

Another potential problem is the probability and propensity for potential errors. One of these such potential errors is with inexperienced workers that take up more time in the construction stage which may delay the building construction. The inexperienced worker may not know when and where a certain piece should be placed and/or how the piece should be attached and/or affixed to the existing building. Another such problem exists with an experienced worker. The experienced worker often times builds from their experience without following the design elements appropriately. Additionally, an experienced worker often deviates from actual specification of the intended construction, which may cause problems to the building design.

A need therefore exists for a device that provides accurate information to construction workers at the site of building construction. Additionally, a need therefore exists for a device, system and method for allowing relatively fast retrieval of construction instruction using GPS technology to follow the specifications of specific design elements implemented by a design team.

Additionally, a need therefore exists for a system and method for providing a construction site worker with the latest GPS technology such that the building construction is effectuated within the proper parameters of the design elements.

### SUMMARY OF THE INVENTION

The present invention relates to an augmented reality building construction apparatus and system. The apparatus and system has a transparent display and a positioning receiver operatively coupled to the display. Additionally, the apparatus and system has an electronically coupled ground-based positioning system and a microprocessor that displays an electronic content on the transparent display and allows for alignment of the electronic content with images in the real world to produce an augmented reality.

Some of the known uses of augmented reality are found in U.S. Pat. No. 6,166,744, U.S. Pat. Pub. No. 2004/0051680 A1, and U.S. Pat. No. 5,815,411. There are also a number of publications (see attached) available regarding experiments performed by Dr. Steven K. Feiner of Columbia University in this field. These and all referenced patents, applications and literatures are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply.

To this end in an exemplary embodiment of the present invention, an augmented reality device is provided. The device has a transparent display and a positioning receiver operatively coupled to the display and electronically coupled to a ground-based positioning system. Additionally, the device has a microprocessor that displays an electronic content on the see-through display and aligns the electronic content with images in the real world to produce augmented reality.

In an exemplary embodiment, the device is a goggle.

In an exemplary embodiment, the device is a binocular.

In an exemplary embodiment, the device is a face shield.

In an exemplary embodiment, the positioning system offers accuracy at centimeter level.

In an exemplary embodiment, the positioning system offers accuracy at millimeter level.

In an exemplary embodiment, the electronic content is a blueprint of a building.

In an exemplary embodiment, the electronic content is a graphical image of an item to be installed at a designated location.

To this end, in an exemplary embodiment of the present invention, a method of building construction is provided. The method comprising the steps of: a user wearing an augmented reality goggle that overlays a graphical indicator with real images of the construction site; and the graphical indicator provides information on building construction.

In an exemplary embodiment, the method comprises the step of: providing a graphical indicator that is an image of an item to be installed at a construction site, and the information is the actual location of where the item is to be installed.

In an exemplary embodiment, the method comprises the step of: wherein the information is provided by overlaying the image of the item with real image of the construction site such that when the user looks through the goggle, the image of the item appears at the desired location according to a construction blueprint.

The present invention provides apparatus, systems and methods of an augmented reality device. In an exemplary embodiment, the device may have a see-through and/or transparent display screen and a positioning receiver operatively coupled to the display screen.

In an exemplary embodiment, the system and method may have an augmented reality device that also has an electronically coupled system for positioning and a microprocessor that displays electronic content on the see-through and/or transparent display screen and aligns the electronic content with images in the real world to produce augmented reality.

Among the many different possibilities contemplated, the positioning system may be a Satellite-based Global Positioning System (GPS), or a locally-based positioning system.

In an exemplary embodiment, the system and method offers accuracy at centimeter level, and more preferably at millimeter level.

It is further contemplated that in the case of a locally-based positioning system, that the system may be a ground-based system involving ground stations for generating positioning signals. These ground stations are preferably movable stations and can be installed around a construction site.

Further, in an exemplary embodiment, the device may include a pair of goggles, a binocular, and a face shield. The idea is to have a user wear a portable device having a see-through and/or transparent display to display electronic content which can include a blueprint of a building, and a graphical image of an item to be installed at a designated location.

In operation, a construction worker uses such augmented reality goggles at a work site. The goggles overlay a graphical indicator with real world images of the construction site so when the user looks through the lens of the goggles and at the real world images of the construction site, additional electronic information is displayed on the lens and is visible to the user. The displayed electronic information can be a graphic indicator providing information on construction plans, an image of an item to be installed at a specific location at the construction site, and the information can provide visual guidance of where the exact location a particular item is to be installed.

For example, a pair of goggles in accordance to one aspect of a preferred embodiment are pre-programmed to display a portion of a blueprint to a building. These goggles have a tracking device, an orientation device, and a positioning receiver that cooperate with positioning stations installed around the construction site. As the user looks through the goggles at a particular location, the goggles overlay images of items with real world image of the construction site. The electronic images appear at the desired location according to the construction blueprint, guiding the user through the construction process.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of a construction site under the coverage of an embodiment of a ground-based positioning system.

FIG. 2A illustrates an augmented reality that indicates where material placement at a construction site in an exemplary embodiment of the present invention.

FIG. 2B illustrates an augmented reality that indicates product placement at a construction site in an exemplary embodiment of the present invention.

FIG. 3 illustrates a portion of the apparatus for use in the construction field in an exemplary embodiment of the present invention.

FIG. 4 illustrates a portion of the apparatus for use in the construction field in an exemplary embodiment of the present invention.

FIG. 5 illustrates another portion of the apparatus for use in the construction field in an exemplary embodiment of the present invention.

### DETAILED DESCRIPTION

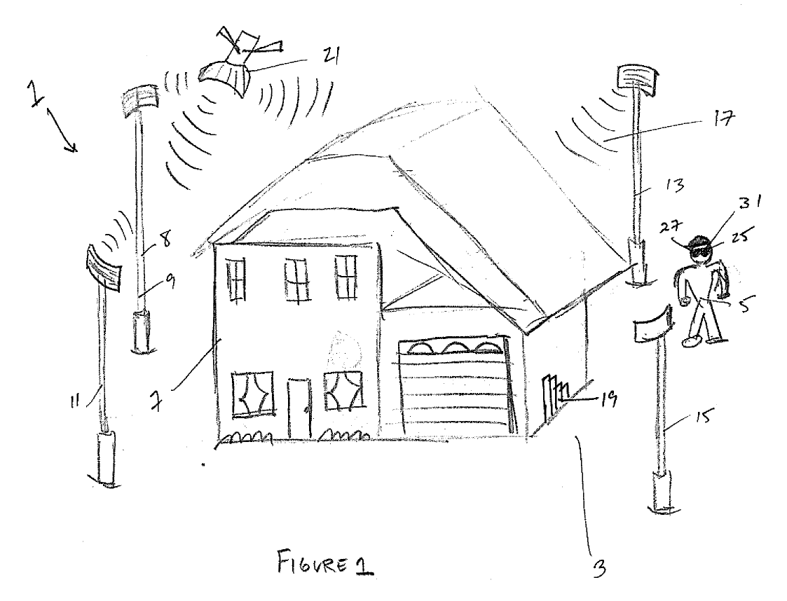

Turning now to the drawings wherein elements are identified by numbers and like elements are identified by like numbers throughout the figures, FIG. 1 illustrates the visual display system 1 that allows for location and positioning of an object at a location on a job site. The system 1 may have multiple configurations but for ease of explanation, only an exemplary embodiment is described herein.

FIG. 1 illustrates the visual display system 1 at a construction site 3. However, it should be noted that the display system 1 does not need to be limited to construction sites 3 but rather may be utilized in a plurality of different settings that may effectuate the use of the system. For illustrative purposes, the present invention discloses an exemplary embodiment wherein the exemplary embodiment is a construction site 3. A construction worker 5 may utilize the system 1 whereby the worker 5 may be able to make judgment calls on location and placement of certain materials on the construction site 3. In an embodiment, the construction worker 5 may be working on the construction of a building 7. In order to use the system 1, the building 7 may be located at a central location around a plurality of ground stations 8. The system may utilize a first ground station 9, a second ground station 11, a third ground station 13 and a fourth ground station 15. However, it should be understood that more or less ground stations may be utilized by the system as needed. In an exemplary embodiment, the ground stations 8 may be used to generate positioning signals 17 to a construction worker 5 at the site of the building 7. The generated positioning signals 17 may be directed to the construction worker 5 to aid in the placement and location of materials 19 needed to properly construct the building 7. The system may allow for easier placement of the materials 19 in the correct positioning such that unnecessary measurements and time consuming preparation work may be effectively eliminated and/or greatly diminished, thereby improving build efficiency and time. The system 1 may be a positioning system utilizing a Satellite-based Global Positioning System (GPS) 21. In this exemplary embodiment, a signal is sent from a satellite 21 to the ground stations 8 whereby the ground stations 8 transmit the signal from the satellite to the individual user utilizing a display means 25. However, it should be understood that the system 1 may utilize a locally-based positioning system (not shown).

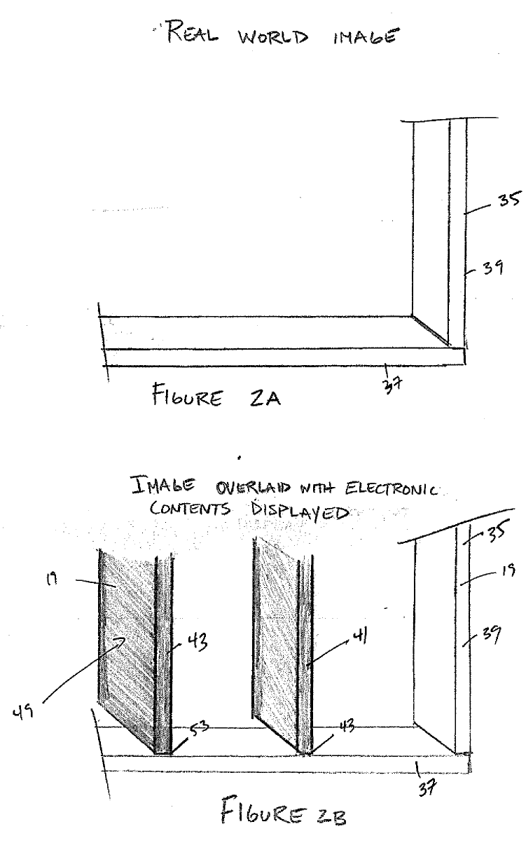

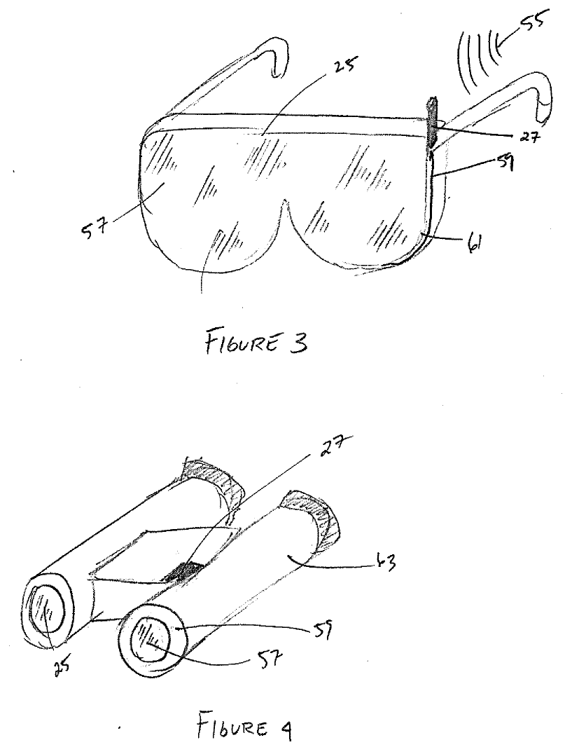

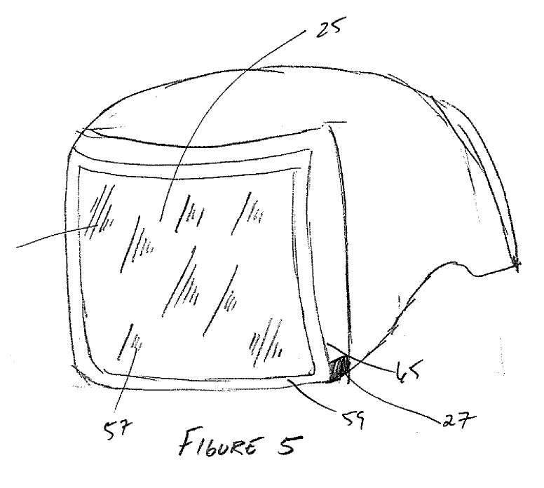

In practice, the system 1 may utilize a global position system that may pin point the area of construction and where each piece of material 19 may need to be placed. The positioning system 1 may utilize a satellite 21 or ground stations 8. A signal is transmitted from either the satellite 21 and/or the ground stations 8 to a display means 25 utilized by the construction worker 5. The display means 25 is further illustrated in FIGS. 3-5. The display means 25 may utilize a microprocessor 27 that may receive the transmitted signal 29 from the satellite and/or ground stations 8. The microprocessor 27 may receive the signal and transform the signal into a visual display as illustrated in FIG. 2B. Further the display means 25 has a see-through portion 31 and/or a transparent portion whereby the construction worker 5 may still be able to see real world materials and devices yet the system may also display the proper positioning of other materials that are not yet in real world applications. (see FIG. 2B)

FIGS. 2A and 2B illustrate a real world image 35 at a construction site 3. In this embodiment, the construction worker 5 may be utilizing the display means 25 and may be able to view the real world image of a material 19 set up at the construction site 3. FIG. 2A illustrates a first portion 37 attached to a second portion 39. The construction worker 5 utilizing the display means 25 may be able to see this real world image 35 but may wish to add a third portion 41 and a fourth portion 43. Normally the worker 5 would have to measure out the exact distances to have proper placement of the third portion 41 and the fourth portion 43 about the first and second portions 37, 39. However, while utilizing the display means 25, the worker 5 may be able to see the real world image 35 and an image overlay 49 of the desired third portion 41 positioning 51 and the fourth portion 43 positioning 53. Thereby, as illustrated in FIG. 2B, the worker 5 may be able to view the real world image 35 with the overlaid image 49 with the electronic contents from the positioning system 1 displayed. The overlaid image 49 may help the worker 5 to properly place the third portion 41 and fourth potion 43 material 19.

An advantage of the satellite 21 positioning system is that it offers a construction worker 5 the ability to place materials 19 in correct positioning within the building 7 with precise accuracy. In an embodiment, the system 1 may offer accuracy of the placement of materials at a construction site 3 at centimeter levels, and more preferably at millimeter levels.

FIGS. 3-5 all illustrated different display means 25 that may be utilized by a worker 5 to illustrate the image overlay of the electronic contents 55 received from the transmitting system 1 to the display means 25. In an exemplary embodiment, the display means 25 has a transparent and/or see through portion 57 whereby the worker 5 may be able to see normal real world images 35. However, the transparent and/or see-through portion 57 may have a plurality of layers wherein at least one layer 59 may be utilized to transpose and display the image overlay 49 directly onto the see-through portion 57.

Additionally, as illustrated in FIG. 3-5, the display means 25 may also utilize a microprocessor 27 that may accept and receive information from the positioning system 1 and may effectuate display of the image overlay 49 onto the see-through portion 57. The microprocessor 27 may be contained on the display means 25 in any position that may be desirable. The display means 25 may take on different configurations as illustrated in the figures. In an exemplary embodiment, the display means 25 may be goggles 61 worn by the worker 5. However, in alternative embodiments, the display means may be binoculars 63, a face shield 65 and/or any other acceptable form of eye protection that may also function to display the electronic content received from the system. The idea is to have a worker/user 5 wear a portable device having a see-through and/or transparent display to display an electronic content which can include a blueprint of a building, and a graphical image of an item to be installed at a designated location.

Thus, specific embodiments and applications of modular overhead storage have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed:

1. An augmented reality device comprising:
a see-through display;
a positioning receiver operatively coupled to the display and electronically coupled to a ground-based positioning system;
a microprocessor that displays an electronic content on the see-through display and aligns the electronic content with images in the real world to produce augmented reality.

2. The device of claim 1, wherein the device is a goggle.

3. The device of claim 1, wherein the device is a binocular.

4. The device of claim 1, wherein the device is a face shield.

5. The device of claim 1, wherein the positioning system offers accuracy at centimeter level.

6. The device of claim 1, wherein the positioning system offers accuracy at millimeter level.

7. The device of claim 2, wherein the electronic content is a blueprint of a building.

8. The device of claim 2, wherein the electronic content is a graphical image of an item to be installed at a designated location.

9. A method of building construction, comprising:
a user wearing an augmented reality goggle that overlays a graphical indicator with real images of the construction site; and
the graphical indicator provides information on building construction.

10. The method of claim 9, wherein the graphical indicator is a image of an item to be installed at a construction site, and the information is the actual location of where the item is to be installed.

11. The method of claim 9 wherein the user is provided with a see-through goggle in order to display the overlaying image onto the real image at a construction site.

12. The method of claim 10, wherein the information is provided by overlaying the image of the item with real image of the construction site such that when the user looks through the goggle, the image of the item appears at the desired location according to a construction blueprint.
